(19) United States
(12) Patent Application Publication
(10) Pub. No.: US 2011/0151575 A1
(43) Pub. Date: Jun. 23, 2011

(54) Energetic Material Detector

(75) Inventors: Mark Fraser, Nashua, NH (US); Ravi K. Konduri, Heathrow, FL (US)

(73) Assignee: L-3 COMMUNICATIONS CYTERRA CORPORATION, Orlando, FL (US)

(21) Appl. No.: 11/963,670

(22) Filed: Dec. 21, 2007

Related U.S. Application Data
(63) Continuation-in-part of application No. 11/940,152, filed on Nov. 14, 2007.
Application No. 11/940,152 is a continuation-in-part of application No. 11/460,586, filed on Jul. 27, 2006, now Pat. No. 7,645,069.
(60) Provisional application No. 60/871,558, filed on Dec. 22, 2006.
(60) Provisional application No. 60/865,771, filed on Nov. 14, 2006.
(60) Provisional application No. 60/702,616, filed on Jul. 27, 2005.
(60) Provisional application No. 60/743,083, filed on Dec. 29, 2005.
(60) Provisional application No. 60/743,402, filed on Mar. 3, 2006.

(51) Int. Cl. G01N 21/72; G01J 1/00; H01J 40/00; G01J 5/00; G01J 1/42

(52) U.S. Cl. 436/155; 250/336.1; 250/200; 250/338.1; 250/208.2

(57) ABSTRACT

Energy released from energized particles is sensed. Whether the energized particles include a possible energetic material is determined based on the sensed energy. If a determination is made that the energized materials include a possible energetic material, a spectral signature of the sensed energy is determined. The spectral signature of the sensed energy is compared to one or more known spectral signatures associated with energetic materials. Whether the possible energetic material is an actual energetic material is determined based on the comparison.

### CROSS-REFERENCE

This application claims priority to U.S. Provisional Application No. 60/871,558, filed Dec. 22, 2006, and titled SPECTRALLY RESOLVED DETECTION. This application is a continuation-in-part of U.S. application Ser. No. 11/940,152, filed Nov. 14, 2007, and titled ENERGETIC MATERIAL DETECTOR, which claims priority to U.S. Provisional Application No. 60/865,771, filed on Nov. 14, 2006, and titled ENERGETIC MATERIAL DETECTOR, and which is a continuation-in-part of U.S. application Ser. No. 11/460,586, filed Jul. 27, 2006, and titled ENERGETIC MATERIAL DETECTOR, which claims priority from U.S. Provisional Application Nos. 60/702,616, filed Jul. 27, 2005, and titled TRACE EXPLOSIVES DETECTOR BASED UPON DETECTING EXOTHERMIC DECOMPOSITION; 60/743,083, filed Dec. 29, 2005, and titled ENERGETIC MATERIAL DETECTOR FOR EXPLOSIVE TRACE DETECTION; and 60/743,402, filed Mar. 3, 2006, and titled ENERGETIC MATERIAL DETECTOR FOR EXPLOSIVE TRACE DETECTION. Each of these applications is incorporated by reference.

### TECHNICAL FIELD

This disclosure relates to detecting energetic materials, such as explosives, based on spectral characteristics of the materials.

### BACKGROUND

In order to detect the presence of substances of interest, samples of the material may be analyzed.

### SUMMARY

In one general aspect, energy released from energized particles is sensed. Whether the energized particles include a possible energetic material is determined based on the sensed energy. If a determination is made that the energized materials include a possible energetic material, a spectral signature of the sensed energy is determined. The spectral signature of the sensed energy is compared to one or more known spectral signatures associated with energetic

Implementations may include one or more of the following features. The spectral signature of the one or more known spectral signatures associated with energetic materials may include spectral emission bands at particular wavelengths, where the spectral emission bands are produced by emissions at the particular wavelengths resulting from thermal decomposition of the energetic materials. Comparing the spectral signature of the sensed energy with the one or more known spectral signatures may include determining whether the spectral signature of the sensed energy includes the spectral emission bands.

If a determination is made that the possible energetic material is an actual energetic material, a classification of the actual energetic material may be determined. Determining a classification of the actual energetic material may included determining a species associated with the actual energetic material. Determining a classification of the actual energetic material may include identifying the actual energetic material as a particular energetic material. Determining a classification of the actual energetic material may include determining that the actual energetic material includes one or more species belonging to a first set of energetic materials. It may be determined that the actual energetic material does not include one or more species of energetic materials belonging to a second set of energetic materials based on the determination that the actual energetic material includes the one or more species belonging to the first set of energetic materials. The first set may include nitrogen and the second set may include non-nitrogen containing species, such as TATP.

An indication may be generated based on the determination of whether the possible energetic material is an actual energetic material. If a determination is made that the possible energetic material is not an actual energetic material, the spectral signature of the sensed energy may be classified as a clutter signature. The clutter signature may be stored in a library of clutter signatures.

The actual energetic material may include an explosive precursor. The actual energetic material may include more than one species of explosive. Determining a spectral signature of the sensed energy may include resolving the sensed energy into spectral emission bands. Determining a spectral signature of the sensed energy may include determining a spectral radiance of the energized samples based on the sensed energy. Determining a spectral signature of the sensed energy may include determining an onset value from the determined spectral radiance, the onset value associated with a wavelength and a magnitude. Comparing the spectral signature of the sensed energy to one or more known spectral signatures may include comparing the determined onset value to onset values associated with known energetic materials.

Specific molar ratios of products and byproducts caused by the oxidation of the energetic materials may be determined. Comparing the spectral signature of the sensed energy to one or more known spectral signatures associated with energetic materials may include comparing the molar ratios of the products and byproducts with known molar ratios of energetic materials.

In another general aspect, a sample energizer is configured to energize a sample area. A sensing component is configured to sense energy radiated from the sample area, and to resolve the sensed energy into one or more spectral bands. An analysis component is configured to determine a spectral signature of the sensed energy and determine whether the sample area includes possible energetic materials based on the spectral signature. If a determination is made that the sample area includes possible energetic materials, the spectral signature is compared to one or more spectral signatures associated with energetic materials. Whether the possible energetic materials include actual energetic materials is determined based on the comparison.

Implementations may include one or more of the following features. The sensing component may resolve the sensed energy into one or more bands using a non-dispersive optic. The non-dispersive optic may include a band-pass filter. The sensing component may resolve the sensed energy into one or more bands using a dispersive optic. The dispersive optic may be a diffraction grating.

The sample energizer may be configured to heat the sample area to 300 degrees Celsius in one second. The sensing component may include a detector. The detector may include at least one photomultiplier tube. The detector may include at least one microbolometer. The detector may include at least one photodiode. The detector may include an array of detectors.

An output component may be configured to produce an indication of whether the sample area includes actual energetic materials. The sample energizer may be a conductive mesh.

In another general aspect, energetic materials are classified. Energy released from energized particles is sensed. The sensed energy is analyzed to determine a spectral radiance of the sensed energy. An onset value is determined based on the spectral radiance, where the onset value includes a wavelength at which the onset occurs. Whether an energetic material is included in the energized particles based on the onset value is determined. The energetic material is classified based on the onset value.

Implementations may include one or more of the following features. An amount of energetic material is determined based on a magnitude of the onset value.

In another general aspect, energetic materials may be classified. Energy released from energized particles at a first time is sensed, and energy released from energized particles at a second time is sensed. The energy sensed at the first time and the energy sensed at the second time is analyzed to determine a first spectral radiance and a second spectral radiance. The first spectral radiance and the second spectral radiance are compared. Whether the energized particles include energetic materials is determined based on the comparison. If a determination is made that the energized particles include energetic materials, the energetic materials may be classified.

Implementations may include one or more of the following features. Comparing the first spectral radiance and the second spectral radiance may include comparing spatial characteristics of the first and second spectral radiances.

Implementations of any of the techniques described above may include a method, a process, a system, a device, an apparatus, or instructions stored on a computer-readable medium. The details of one or more implementations are set forth in the accompanying drawings and the description below. Other features will be apparent from the description and drawings, and from the claims.

### DESCRIPTION OF DRAWINGS

FIG. 1 illustrates a plan view of an example thermal decomposition system.

FIGS. 2 and 5 show diagrams of examples of spectral signature data.

FIG. 3 is a block diagram of a an example thermal decomposition system.

FIGS. 4A, 6, and 8 are flow charts of example processes for discriminating between energetic materials and clutter.

FIG. 4B is a flow chart of an example process for determining whether possible energetic materials are present.

FIGS. 4C-4F show illustrations of thermal signature data.

FIG. 7 illustrates a side view of an example thermal decomposition system.

FIGS. 9A and 9B illustrate side views of example thermal decomposition systems.

FIG. 10 illustrates an example impact collector.

FIGS. 11A-11C illustrate an example of a collection and detection system.

FIG. 12A illustrates an example hand-held detection system.

FIG. 12B illustrates an example ranged detection system.

### DETAILED DESCRIPTION

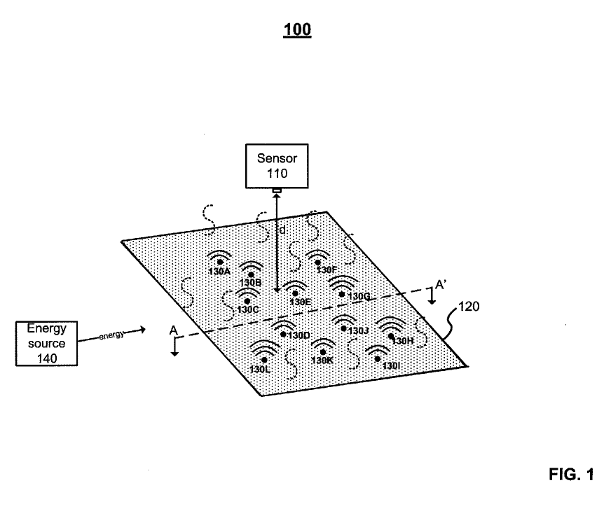

Referring to FIG. 1, a plan view of an example thermal decomposition system 100 is shown. The system 100 may be used to improve the probability of detecting trace amounts of substances of interest (such as explosives) while also reducing the rate of false alarms (e.g., an erroneous determination that explosives are present). In particular, the system 100 analyzes a spectral signature produced by a heated substance to determine whether the substance is an explosive or other substance of interest such as an explosive precursor. The spectral signature includes information about emissions from a substance at particular wavelengths.

Reducing the false alarm rate allows the system 100 to operate more efficiently and to examine more objects for possible energetic materials. For example, the system 100 may be used at an airport to screen luggage to determine if the luggage should be prevented from being loaded onto an airplane because the luggage contains explosives. In this example, reducing the false alarm rate while maintaining a high probability of detection may result in, for example, fewer pieces of luggage being marked as suspicious. Marking fewer pieces of luggage as suspicious may reduce the number of pieces of luggage that must be checked manually by security personnel, which may allow the personnel to focus more time and energy on the luggage most likely to contain dangerous items, or allow examination of more pieces of luggage within the same amount of time. The system 100 determines whether samples on a collection surface include possible energetic materials (e.g., explosives). Additionally, the system 100 may determine whether the samples include substances such as acetone or hydrogen peroxide, which are not inherently explosives but can be made into explosives (such substances may be referred to as “explosive precursors”).

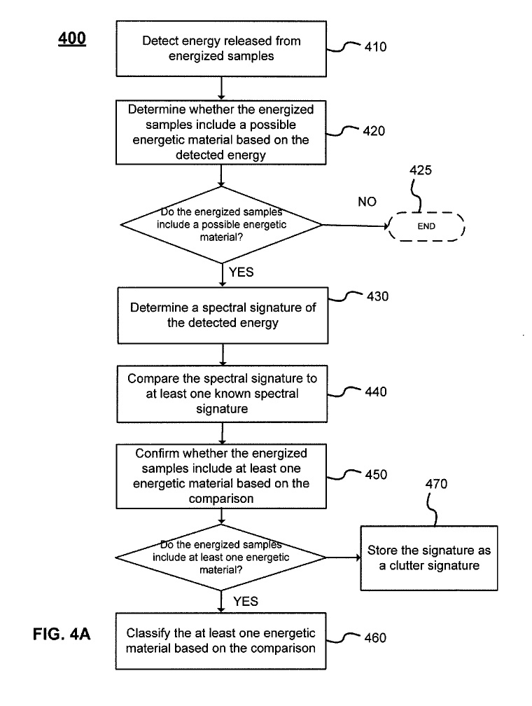

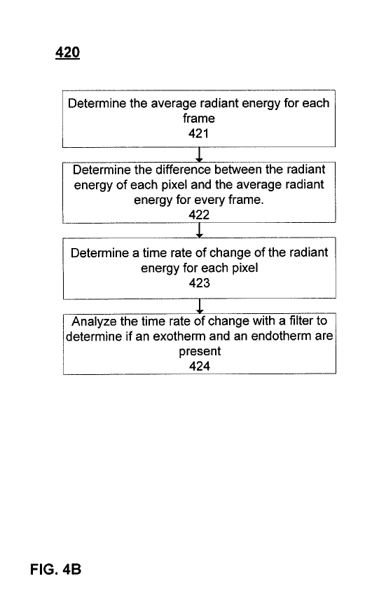

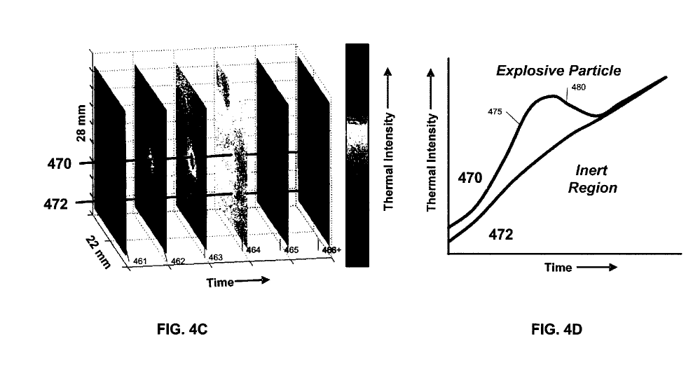

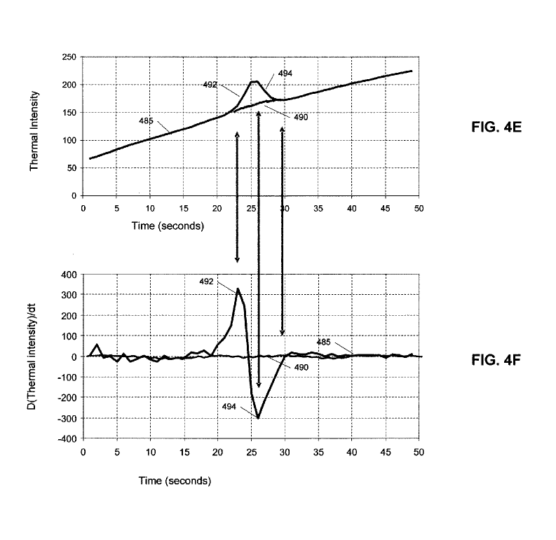

In greater detail, the system 100 includes a sensor 110 located a distance “d” from a surface 120. Samples 130A-130L of one or more materials are located on the surface 120, and the samples 130A-130L emit radiation as the surface 120 is heated by an energy source 140. The samples 130A-130L may be, for example, particles of materials. The sensor 110 monitors the changing emissivity of the surface 120 (and the samples 130A-130L) as the surface 120 is heated by the energy source 140 to a temperature sufficient to initiate thermal decomposition of the samples 130A-130L. The emissions produced by the thermal decomposition of the samples 130A-130L are sensed by the sensor 110 and spectrally resolved. The spectrally resolved emissions are analyzed to determine whether the samples 130A-130L include energetic materials, and if so, the system 100 classifies the energetic materials. The spectrally resolved emissions may be analyzed and used to augment other detection techniques based on other physical properties of the thermal decomposition (such as detection techniques based on thermal signatures of energetic materials as discussed with respect to FIGS. 4B-4E). In some implementations, the spectrally resolved emissions may be used to detect the presence of energetic materials without using other detection techniques.

The example shown in FIG. 1 includes the sensor 110. However, in some implementations, the system 100 may include more than one sensor. In these implementations, the sensors may be sensitive to energy of the same or different wavelengths.

As described in more detail below, the system 100 determines whether the samples 130A-130L include trace amounts (e.g., as low as single-digit nanogram amounts) of certain substances of interest, such as energetic materials, explosive precursors, or other hazardous substances by analyzing the emission spectra produced by the samples 130A-130L as the samples 130A-130L are heated to a temperature sufficient to trigger thermal decomposition of the samples 130A-130L.

Thermal decomposition is a chemical reaction in which a heated substance is thermally decomposed or oxidized into at least two other chemical substances. The other chemical substances may considered products and/or byproducts of the thermal decomposition. For example, the following reaction represents the thermal composition of a generic energetic material, CₓH_{y}O_{z}Nₐ:

CₓH_{y}O_{z}Hₐ+bO₂→xCO₂+(y/2)H₂O+aNO₂ (1)

The specific molar ratios of carbon dioxide (CO₂), water (H₂O), and nitrogen dioxide (NO₂) depend upon the composition of the initial energetic material, which is determined by the values of x, y, z, and a. In addition to carbon dioxide, water, and nitrogen dioxide, other products may be produced by the oxidation. For example, the reaction may produce nitric oxide (NO), carbon monoxide (CO), and/or formaldehyde (H₂CO).

The heat released from the decomposition process represented by Equation 1 is initially manifested in translation, electronic, and rovibrational excitation of the products and byproducts. Relaxation processes such as quenching, radiation, and conduction, transfer a fraction of the heat released from the decomposition process into the localized environment. The release of heat produces a black body emission continuum that may be detected by a broadband thermal sensor. For example, the released heat may be detected by a sensor that is sensitive to radiation having wavelengths between 8 and 20 microns. Analysis of the released heat as a function of time can reveal whether the particles include energetic materials or other substances of interest.

Additionally, emissions from the products and byproducts of the thermal decomposition in the near-ultraviolet, visible, near-infrared, and infrared spectral regions may be detected and spectrally resolved. These spectral emissions may be used to determine whether the samples are energetic materials or other substances of interest. Because the thermal decomposition of a particular substance produces unique products and byproducts each having a unique enthalpy of reaction, the observed emission spectra of the products and byproducts produced by the thermal decomposition is unique to the original compound that underwent thermal decomposition. Thus, the observed emission spectra of the products and byproducts provides a unique identification of the original compound that underwent thermal decomposition.

Accordingly, the system 100 determines whether the samples 130A-130L include possible energetic compounds by, for example, analyzing the radiant energy produced by the thermal decomposition of the samples 130A-130L. Additionally, emissions observed from the heated energetic material may be detected and separated by the wavelengths included in the energy detected to produce a spectral signature. Whether the possible energetic compounds are actual energetic compounds is confirmed by analyzing the observed spectral emissions produced by the thermal decomposition and comparing the observed spectra to the emission spectra of materials known to be energetic materials. In addition to confirming whether the samples 130A-130L include energetic materials, by comparing the observed spectra to the spectra of known materials, the samples 130A-130L can be classified as belonging to a class of energetic materials or classified as a particular energetic material.

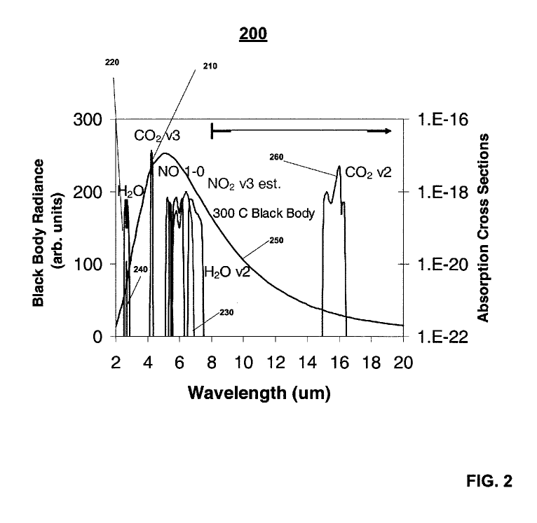

Referring to FIG. 2, an example of spectral signature data is shown. More particularly, FIG. 2 shows an example emission spectra 200 produced by the thermal decomposition or oxidation of an energetic material is shown. The example emission spectra 200 includes emission bands arising from carbon dioxide (210), water (220), nitrogen dioxide (230), and nitric oxide (240). The 300° C. blackbody radiance curve 250 is shown for comparison. Additionally, some species produce multiple emission bands, each of which correspond to different vibrational modes of the species. For example, an emission band 260 corresponds to a second vibrational mode for carbon dioxide. The specific molar ratios of the products and byproducts of the oxidation depend on the energetic material that underwent oxidation and the molar ratios may be determined by analyzing the emission spectra. Thus, analysis of the emission spectra allows unique identification of the energetic material.

Spectral fitting techniques may be applied to the spectral signature to classify the energetic material. For example, the absolute emission magnitudes including the rovibrational envelopes of the observed emissions may be determined and used to classify and/or identify the original material. In particular, the spectral signature may be used to determine whether or not the original material is an energetic material, an explosive precursor, or another hazardous material by comparing to the spectral signature produced from the oxidation of the original material with the spectral signature associated with other substances. In addition to the emission bands of the products and byproducts shown in FIG. 2, other products and byproducts may be produced as a result of the oxidation of the energetic material and these other products and byproducts also have associated emission bands.

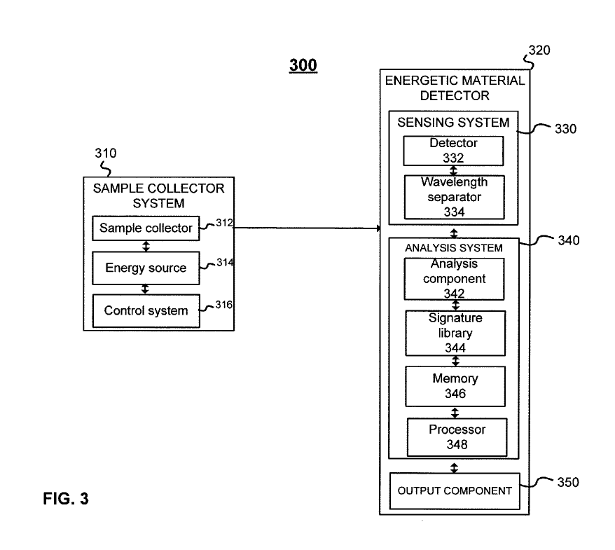

Referring to FIG. 3, a block diagram of an example thermal decomposition system 300 is shown. In more detail, the system 300 determines whether possible energetic materials, or other substances of interest, are present. If possible energetic materials are present, the system 300 determines whether the possible energetic materials are actual energetic materials, and classifies any actual energetic materials. Thus, by determining whether possible energetic materials are actual energetic materials, the system 300 may reduce the number of false alarms produced by the system 300 while maintaining a high probability of detection.

The system 300 includes a sample collector system 310 that collects and heats samples of substances. The system 300 also includes an energetic material detector 320 that senses energy released from the samples and analyzes the energy to determine whether a possible energetic material is present in the samples. If a possible energetic material is present, the energetic material detector 320 determines whether an actual energetic material is present, and, if an actual energetic material is present, the energetic material detector 320 classifies the actual energetic material.

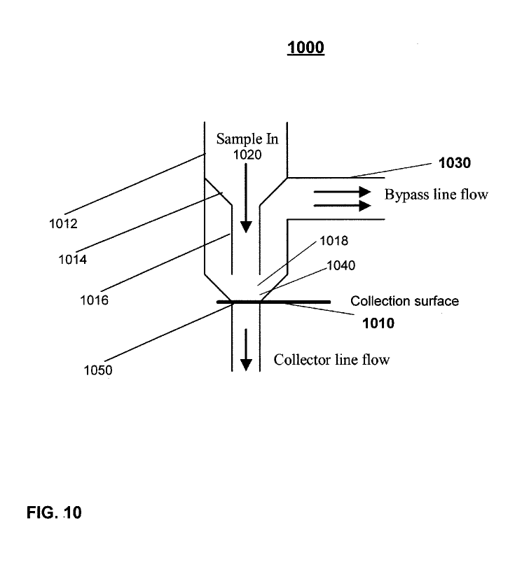

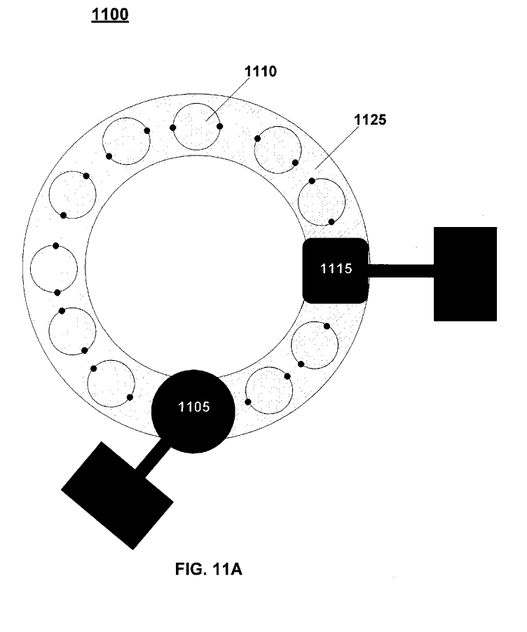

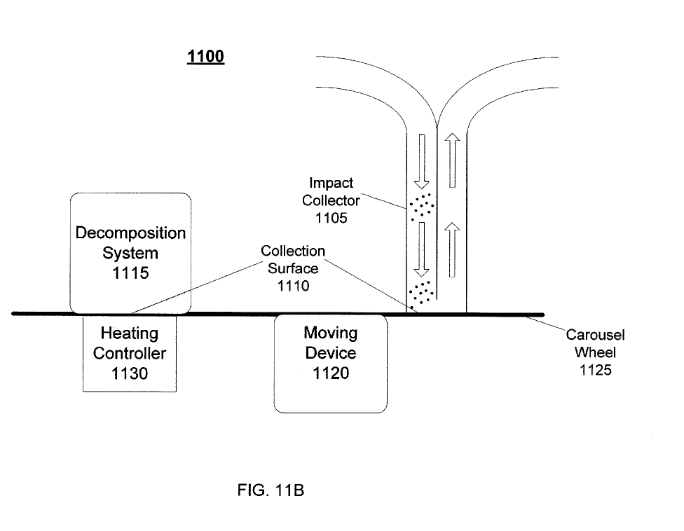

In greater detail, the sample collector system 310 includes a sample collector 312, an energy source 314, and a control system 316. The sample collector 312 may be made from a material such as, for example, TEFLON® available from E.I. Du Pont De Nemours Corporation of Wilmington, Del., a metal mesh, woven carbon fibers, a deactivated glass wool pad, a nichrome wire or ribbon, any type of metal, aluminum coated polimide, or carbon-filled poluimide. In some implementations, the sample collector 312 may be removable from the sample collector system 310 such that the sample collector 312 can be brought into contact with an object of interest or an object under evaluation (such as a suitcase). The samples collected or harvested by the sample collector 312 may be collected by swiping the sample collector 312 over a person or object to be examined for the purpose of detecting trace amounts of energetic materials. For example, a person who is involved in packing explosives into a suitcase generally accumulates trace amounts of the explosive on their hands. The person also generally tracks trace amounts of explosives onto the surface of the packed suitcase and other objects that the person touches. By bringing the sample collector 312 into contact with the surface of the suitcase, trace amounts of the explosive are collected onto the sample collector 312. These trace amounts of explosives may be referred to as samples of the explosive material. In other implementations, for example as discussed with respect to FIG. 10, the samples may be deposited onto the sample collector 312.

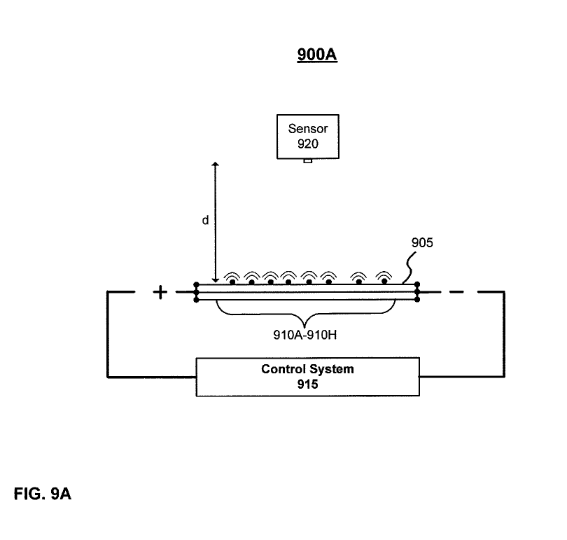

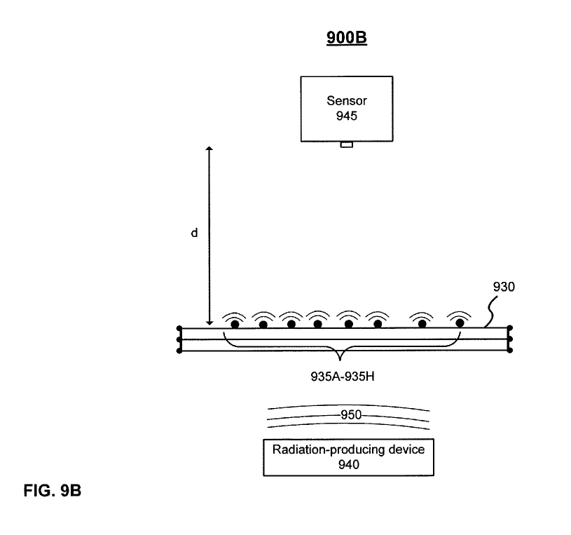

In some implementations, the sample collector may be attached to the sample collector system 310 such that the sample collector 312 collects and harvests samples by having items brought into contact with the sample collector 312. For example, the sample collector 312 may be part of a turnstile, and the sample collector 312 may be arranged within the turnstile such that persons and objects passing through the turnstile come into contact with the sample collector 312. The sample collector 312 may be the surface 120 described above with respect to FIG. 1. If the energy source heats the sample collector 312 through resistive heating, the sample collector 312 is a conductive material. In these implementations, the sample collector 312 may be, for example, foil or a metal mesh. In other implementations, such as the implementation shown in FIG. 9B, the sample collector 312 may be radiatively heated. In these implementations, the sample collector 312 may be a non-conductive material.

The sample collector system 310 also includes an energy source 314 that is coupled to the sample collector 312. The energy source 314 heats the sample collector 312 such that the samples on the sample collector 312 are heated and undergo thermal decomposition. In some implementations, the energy source 314 heats the sample collector 312 to 300° C. in one minute or less. The control system 316 controls the energy source 314.

The energy released from the thermal decomposition of the samples on the sample collector 312 is sensed and analyzed by the energetic material detector 320. The energetic material detector 320 includes a sensing system 330, an analysis system 340, and an output component 350. The sensing system 330 includes a detector 332 that senses energy produced as the sample collector 312 is heated. The sensing system 330 is configured to detect energy in multiple spectral regions (which also may be referred to as spectral bands). In some implementations, the sensing system 330 detects energy having wavelengths of 200 nanometers to 20 microns. The detector 332 may include a detector that senses broadband thermal energy, such as an infrared detector or a microbolometer. The infrared detector may be sensitive to, and detect energy in, the near-infrared (e.g., energy having wavelengths of 0.75-1.4 microns), short-wavelength infrared (e.g., 1.4-3 microns) mid-wavelength infrared (e.g., 3-8 microns), long-wavelength infrared (e.g., 8-12 microns), and/or far-wavelength infrared (e.g., greater than 15 microns). The detector 332 also may include a detector that senses energy in the visible band (e.g., 400-800 nanometers), such as a photomultiplier tube or a photodiode. The detector 332 also may include a detector that senses energy in the near-ultraviolet spectral band (e.g., 200-400 nanometers).

The detector 332 may include multiple detectors sensitive to energy of various wavelengths. For example, the detector 332 may include detectors that sense energy in all of the spectral bands discussed above. In some implementations, the detector 332 may be arranged in one or more lines of detectors. In some implementations, the detector 332 may include an array of detectors or sensors. For example, the detector 332 may be an array of 320×240 sensors. In this implementation, the detector 332 may collect images of the sample collector 312 as it is heated. For example, the detector 332 may collect 60 images of the sample collector 312 each minute. Thus, this implementation allows analysis of the sample collector both temporally and spatially.

The sensing system 330 also includes a wavelength separator 334 that divides the energy sensed by the detector 332 into one or more spectral bands. Dividing the sensed energy into one or more spectral bands allows the determination of a spectral signature because the amount of energy sensed at each wavelength, or in a range of wavelengths, may be determined. The wavelength separator 334 may be a dispersive device that disperses the energy sensed by the detector 332, which includes energy of many different wavelengths, into individual wavelengths. Examples of dispersive devices include prisms and diffraction gratings. In some implementations, the wavelength separator 334 may be a non-dispersive device such as a band-pass filter. The band-pass filter may be used to separate the energy sensed by the detector 332 into wavelength bands. The bandwidth of the band-pass filter may range from a few nanometers (e.g., for band-pass filters used to filter energy having wavelengths in the visible spectral band) to half a micron (e.g., for band-pass filters used to filter energy having wavelengths in the mid-wave and long-wave infrared). In some implementations, the band-pass filter may be made from coated optics that transmit energy having particular wavelengths while preventing the transmission of energy having any other wavelength. For example, the band-pass filter may pass energy having a wavelengths between 3.2 microns and 3.3 microns and block the transmission of energy having any other wavelength.

The energy sensed by the sensing system 330 is analyzed by the analysis system 340 to determine whether the samples on the sample collector 312 include substances of interest, such as energetic materials, explosive precursors, or other hazardous materials. The analysis system 340 includes an analysis component 342, a signature library 344, a memory 346, and a processor 348.

The analysis component 342 analyzes the energy detected by the detector 332 and separated by the wavelength separator 334 to determine whether the samples on the sample collector 312 include possible energetic materials, or other substances of interest. For example, the analysis component 342 may analyze the radiant energy detected by an infrared sensor included in the detector 312 to determine a temporal profile of the radiant energy of the samples on the sample collector. Based on the temporal profile, the analysis component 342 may determine that the particles include a possible energetic material. The analysis component 342 may then determine a spectral signature of the energy sensed from the heated samples to confirm whether the samples include actual energetic materials. The spectral signature may be an emission spectra such as the one shown in FIG. 2. From the determined spectral signature, the analysis component 342 may determine values for the variables x, y, z, and a included in Equation 1. For example, the values of the variables x, y, z, and a may be determined from the values of the absorption cross sections shown in FIG. 2. To determine whether the samples include actual energetic materials, the analysis component 342 may compare the spectral signature to data included in the signature library 344.

The signature library 344 includes data that represents spectral signatures of particular substances. For example, the signature library 344 may include the specific molar relationships of the products and byproducts of the oxidation of particular energetic materials, such as the oxidation of an energetic material represented by Equation 1 above. Thus, the signature library may include the values of the variables x, y, z, and a included in Equation 1 for many different explosives (such as RDX and TNT), explosive precursors, and other substances of interest. The signature library also may include ranges of values of the variables x, y, z, and a that correspond to explosives belonging to a class of explosives. Additionally or alternatively, the signature library 344 may include data that represents spectral signatures of various substances. In some implementations, the signature library 344 includes data that represents spectral signatures of substances that are not of interest (e.g., substances that are clutter), such as cloth and dust. The signature library may be implemented, for example, as a database, a file, or a spreadsheet.

The memory 346 stores the signature library 344. The memory 346 also stores instructions that, when executed by the processor 348, cause the analysis component to perform operations such as determining the spectral signature of the samples on the sample collector 312 and determining whether the samples on the sample collector 312 include possible substances of interest. The memory 346 also stores instructions that, when executed by the processor 348, cause the analysis component 342 to interact with the signature library 344 to retrieve data from and/or add data to the signature library. The memory 346 also stores data collected by the detector 332 and instructions for collecting the data from the detector 332. The memory 346 may be any type of computer-readable medium.

The output component 350 produces an indication of whether the samples on the sample collector 312 include energetic materials or other substances of interest. The output component 350 may be, for example, a display, a sound, or any other output device. In some implementations, the output component 350 displays a visual indication of whether or not the samples include energetic materials. In some other implementations, the output component 350 produces a sound only when energetic materials are present in the samples on the sample collector 312. In some implementations, the output component 350 produces a variety of sounds, and a sound may represent the presence or absence of energetic materials.

In the example system 300, the sample collector 312, the energy source 314, and the control system 316 are shown as being separate from the energetic material detector 320. However, in some implementations, the sample collector 312, the energy source 314, and the control system 316 may be located with the energetic material detector 320 in a unitary device.

Referring to FIG. 4, a flow chart of an example process 400 for discriminating between energetic materials and clutter is shown. In particular, the process 400 is used to improve or maintain a high probability of detection (e.g., at least 90%) of energetic materials while also reducing the false alarm rate as compared to a process that does not consider spectral signature data. In some implementations, the false alarm rate may be reduced to a rate that is less than 1%.

False alarms occur when a sample that is clutter (such as a cloth fiber, a droplet of water, or a dust particle) is classified as a substance of interest (such as an energetic material or an explosive precursor). The process 400 may be performed by a system such as the system 100 or the system 300 described above.

Energy released from energized samples is detected (410). The samples may be on the sample collector 312 discussed above with respect to FIG. 3. The samples may be energized by heating the sample collector 312 to a temperature sufficient to cause energetic materials to undergo thermal decomposition.

Whether the energized particles include a possible energetic material is determined based on the detected energy (420). For example, the detected energy may be radiant energy released from the samples as they are heated. The detected radiant energy may be analyzed to determine whether the samples include a possible energetic material. For example, and as discussed in greater detail with respect to FIG. 4B, the detected radiant energy may be used to determine a time-dependent thermal signature of the samples. The characteristics of a time-dependent thermal signature associated with energetic materials are different than the time-dependent thermal signature associated with clutter materials. For example, the time-dependent thermal signature associated with energetic materials includes both an exotherm (a rapid release of energy) and an endotherm (a cool down to the background). In contrast, the time-dependent thermal signature of clutter generally do not include an endotherm and an exotherm. Thus, analysis of the time-dependent thermal signature allows a determination of whether the samples include energetic materials. Other techniques may be used to determine whether the sample includes possible energetic materials.

If it is determined that the samples do not include possible energetic materials, the process 400 may terminate (415). In some implementations, the process 400 may continue if the determination that the samples do not include possible energetic materials is above a certain threshold. In some implementations, the process 400 may continue regardless of whether it is determined that the samples include possible energetic materials.

If it is determined that the samples include possible energetic materials, a spectral signature of the detected energy is determined (430). The spectral signature may be the emission spectra caused by the heating and/or thermal decomposition of the samples. The spectral signature is compared to at least one known spectral signature (440). For example, the determined spectral signature may be compared to the known spectral signatures of various explosives. The known spectral signatures may be stored in a signature library such as the signature library 344 discussed above with respect to FIG. 3. In some implementations, comparing the determined spectral signature to the known spectral signatures may include comparing molar ratios determined from the emission spectra of the samples to the molar ratios of the known energetic materials. In some implementations, comparing the determined spectral signature to the known spectral signatures may include comparing data representing the determined spectral signature to data representing the known spectral signatures. The determined spectral signature may be compared to known spectral signatures of particular energetic materials, or the determined spectral signature may be compared to one or more spectral signatures associated with a type or class of energetic materials.

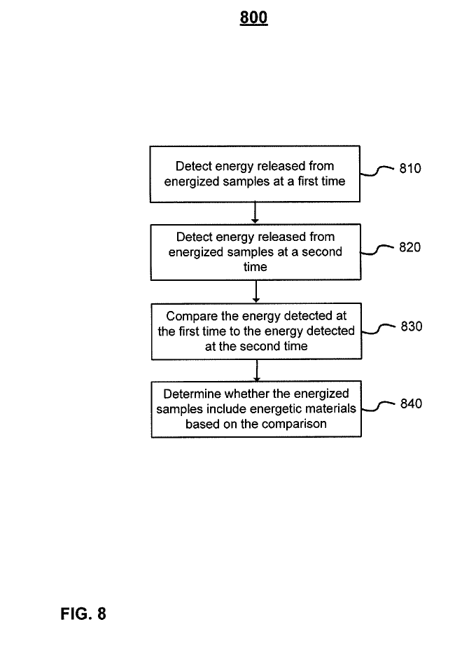

In some implementations, additional or alternative features of the determined spectral signature may be used to compare the determined spectral signature to the known spectral signature. For example, and as discussed in more detail below with respect to FIG. 6, an onset value may be determined from the spectral signature and compared to the onset values of substances known to be energetic materials. In another example, and as discussed in more detail below with respect to FIG. 8, the characteristics of the signatures at different times may be used in the comparison.

Whether the samples include at least one actual energetic material is confirmed based on the comparison (450). For example, if the determined spectral signature matches a signature known to be associated with an energetic material, the sample is deemed to include at least one energetic material. In some implementations, a match may be made even if the determined spectral signature differs from the signature known to be associated with an energetic material. By confirming whether the samples include an actual energetic material, the process 800 may reduce the number of false alarms while still maintaining a high probability of detection.

If the samples are confirmed to include at least one actual energetic material, the at least one actual energetic material is classified based on the comparison (460). Classifying the energetic material may include identifying the energetic material as a particular energetic material. For example, the energetic material may be classified by identifying the energetic material as the RDX explosive. In some implementations, classifying the at least one energetic material may include determining that the energetic material belongs to a class of energetic materials that share a common characteristic such as explosives that are derived from a common formula or explosives that have a specific volatility. For example, classifying the energetic material may include determining that the energetic material is a plastic explosive or a commercial explosive. In another example, classifying the energetic material may include determining that the energetic material is an a member of a class of explosives that do not include a particular chemical. For example, the sample may be classified as including an explosive, such as TATP, that does not include nitrogen.

In some implementations, if there is not a confirmation that the samples include an actual energetic material, the determined spectral signature may be classified as a clutter signature (470). The clutter signature may be stored in a signature library and used to screen subsequently encountered clutter.

Referring to FIG. 4B, an example process 420 determines whether energized samples include possible energetic materials. In more detail, the example process 420 analyzes a time-dependent thermal signature to determine the possible presence of an energetic material. The process 420 determines whether a possible energetic material is present based on analysis of a time-dependent thermal signature generated from data collected by a detector array used to monitor a thermal energy status of a sample area as the samples are heated. The detector array may be, for example, the detector 332 discussed above, and the detector array may be a long-wave or mid-wave infrared detector. The detector 332 may be an array and/or the detector 332 may include additional detectors sensitive to energy of other wavelengths. The thermal energy status of the sample area may be the radiant energy released from or absorbed by the sample area and/or it may be the temperature of the sample area. In general, the heat released from the sample area as it is heated may be detected by the detector as radiant energy. The detected radiant energy may be used to determine a time-dependent thermal signature of the sample area. In other implementations, the detected radiant energy may be converted to a corresponding temperature. In this implementation, the time-dependent thermal signature is based on the temperature of the sample area as the sample area is heated over time.

As discussed in more detail below, analysis of the time-dependent thermal signature for characteristics of an explosion may allow a determination of whether the sample area includes possible energetic materials. For example, supplying an explosive material with sufficient energy causes the material to explode. When the explosion occurs, heat is released from the explosion into the surrounding environment. This heat release may be referred to as an exotherm, and the exotherm is typically characterized by a rapid increase in the radiant energy released from the sample area. The explosive material is consumed during the explosion. After the explosive material is consumed, the explosion ends, and the sample area cools to the surrounding temperature. This cooling may be referred to as an endotherm. The endotherm is typically characterized as a decrease in the radiant energy released from the sample area. Thus, time-dependent thermal signatures of explosives include an exotherm (a rapid rise in radiant energy over a first time interval) followed by an exotherm (a decrease in radiant energy over a second time interval). Because time-dependent thermal signatures of materials other than explosives generally do not include an exotherm followed by an endotherm, the presence of an exotherm followed by an endotherm in a time-dependent thermal signature indicates that the thermal signature was created by heating an energetic material. For example, analyzing thermal signatures for the presence of an exotherm and an endotherm allows a determination of whether possible energetic materials are present without comparing the thermal signature to signatures included in a predefined library of thermal signatures.

The process 420 analyzes the radiant energy released over time from the sample area to determine if the sample area includes a possible energetic material. As discussed above, the radiant energy of a sample area is monitored using, for example, an infrared camera or a detector such as the detector 332.

Referring to FIG. 4C, an illustration of thermal signature data is shown. For example, such data may be used in the process 420. In the example shown in FIG. 4C, data is collected using, for example, an infrared sensor (which may be the detector 332) by taking snapshots, or frames, (such as snapshots 461, 462, 463, 464, 465, and 466) of the samples at various times. In this example, the collected data shows the heat released from the samples as a function of time. In the example shown in FIG. 4C, the infrared sensor that includes an array of 320×240 pixels monitors a sample area that is 28 millimeters tall and 22 millimeters wide. The frames may be collected at regular intervals. For example, the frames may be collected at a rate of 60 frames per minute such that one frame is collected every 16.7 milliseconds. The example shown in FIG. 4C includes six frames, however more or fewer frames may be collected. For example, the frames may be collected for two seconds.

The process 420 analyzes the frames to determine a time-dependent thermal signature of each pixel, and the thermal signature is used to determine whether possible energetic materials are present. The frames 461, 462, 463, 464, 465, and 466 image the sample area and include a target region 470 and an inert region 472. In the example shown in FIG. 4C, the target region 470 includes explosive materials and the inert region 472 does not. The inert region 472 also may be referred to as the background or the surrounding region. As seen in FIG. 4C, as heat is applied to the sample area, the amount of heat released from the target region 470 is different from that released from the inert region 472.

Referring again to FIG. 4B, the average radiant energy is determined for each frame (421). For example, the value of each pixel in each of the frames 461, 462, 463, 464, 465, and 466 may represent the radiant energy released by the region of the sample area imaged by the pixel. Thus, the average value of the pixels in the frame 461 represents the average radiant energy released by the sample area at the time when frame 461 was collected. In another example, each pixel in each of the frames 461, 462, 463, 464, 465, and 466 may be converted from radiant energy to temperature. In this example, the average of the values of the pixels in the frame represents the average temperature of the sample area.

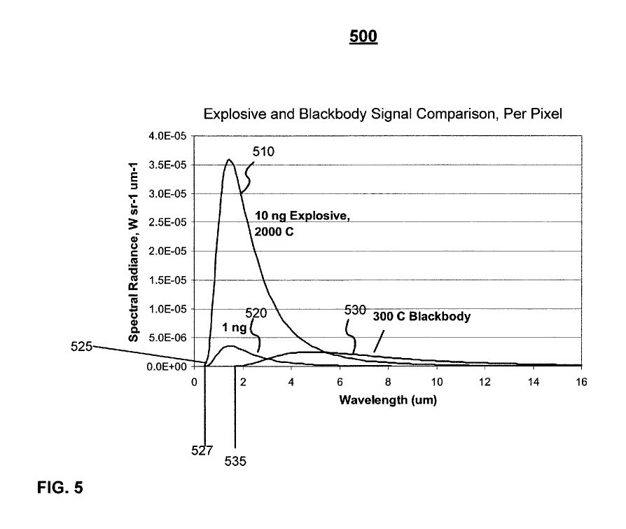

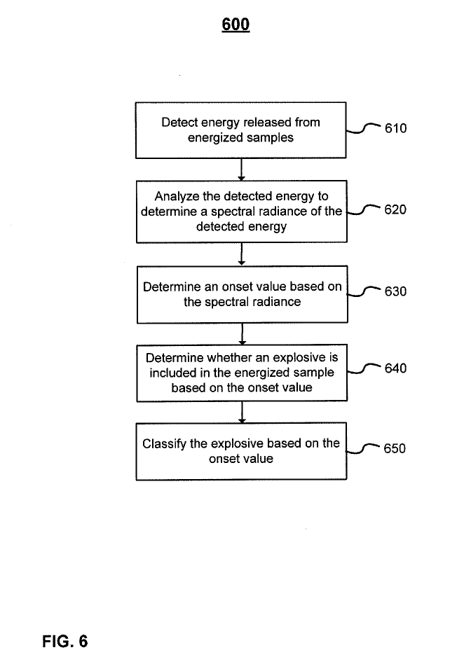

The difference between the radiant energy at each pixel and the average value is determined for each pixel in each frame (422). Thus, the average value for a particular frame determined in (421) is subtracted from the value of each pixel in that frame. Accordingly, the thermal energy status (e.g., the radiant energy or temperature) as a function of time may be determined for each pixel. Referring to FIG. 4D, an illustration of thermal signature data is shown. In the illustration, an example of the radiant energy of the pixel 470 and the pixel 472 as a function of time are shown. In contrast to the spectral signature shown in FIGS. 2 and 5 (which show emissions as a function of wavelength), the example in FIG. 4D shows the thermal signature of as a function of time. In this example, the pixel 472 images a portion of the sample area that does not include energetic materials, and the pixel 470 images a portion of the sample are that includes explosive material. As compared to the pixel 472, the radiant energy of the pixel 470 increases at time 475 (an exotherm) as the energetic materials the pixel images are heated and explode and the radiant energy of the pixel 470 decreases at time 480 as the explosion consumes the energetic material and the area that the pixel 470 is imaging cools (an endotherm).

Referring to FIG. 4B again, a time rate of change (e.g., a derivative with respect to time) is determined for each pixel (423). The time rate of change may be the time rate of change of the radiant energy or the temperature. FIGS. 4E and 4F show an illustration of thermal signature data. In the illustration, an example of the radiant energy and the time rate of change of the radiant energy detected by a pixel that images energetic materials, such as the pixel 470, and a pixel that images a region without energetic materials, such as the pixel 472, respectively. In particular, FIG. 4E is an illustration of thermal intensity versus time for a pixel 485 that images a region that includes explosive material and a pixel 490 that images a region without explosive material. FIG. 4F is an illustration of a derivative with respect to time for the radiant energy detected by the pixels 485 and 490. The time rate of change of the pixel 485 may be determined by comparing the value of the pixel 485 in one with the value of the same pixel in a previously or subsequently collected frame. The time rate of change may be determined in any manner that a derivative may be determined. For example, the comparison may be a subtraction, and the resulting value is generally divided by the time that elapsed between collection of the frames. In general, the comparison is performed between the same pixel in two different frames after the average value for each frame is subtracted. However, in some implementations, the comparison may be done without subtracting the average value from the frames.

Accordingly, the time rate of change for each pixel is determined. The time rate of change may be the time rate of change of the radiant energy detected by that pixel or the time rate of change of the temperature of the region of the sample area the pixel is imaging. The time rate of change for each pixel may be the time-dependent thermal signature of the region of the sample area that is imaged by the pixel. In other implementations, the time-dependent thermal signature may be the radiant energy of the pixels over time. In still other implementations, the time-dependent thermal signature may be the temperature of each pixel over time. Referring to FIG. 4E, the time rate of change of the pixel 485 includes an exotherm 492 and an endotherm 494. The endotherm 492 and exotherm 494 are also apparent in the data shown in FIG. 4F. The presence of the exotherm 492 and the endotherm 494 indicates that an explosive is present.

Referring again to FIG. 4B, the time rate of change (e.g., time-dependent thermal signature) determined for each pixel in (423) is analyzed by a filter to determine whether an exotherm and an endotherm are present in the time-dependent thermal signature (424). Based on whether an endotherm and an exotherm are present, the presence of a possible energetic material may be determined.

In the example above, a process such as the process 420 may be used to determine whether the sample includes possible energetic materials. However, other techniques may be used to determine whether the sample includes possible energetic materials. For example, the spectral signature data may be used to determine whether the sample includes possible energetic materials.

Referring to FIG. 5, a diagram of an example of spectral signature data is shown. In particular, a diagram 500 of spectral radiance emitted from an explosive material heated to 300° C. as compared to a 300° C. blackbody is shown. In contrast to FIG. 2, the diagram 500 shows an example of how detection of energy at additional wavelengths below 2 microns can improve the lower limit of detection, which may improve the classification of energetic materials and other substances of interest because many emissions from such substances occur at wavelengths shorter than 8 microns. In the example shown in FIG. 5, the spectral radiance determined from emissions measured using a detector sensitive in the visible band, the near infrared band, and/or the short wave infrared band. As shown in FIG. 5, the spectral radiance is expressed in units of Watts per steradian per wavelength. Thus, the spectral radiance is a representation of the radiation emitted from the heated samples as a function of wavelength. In the example shown, the emission is measured over wavelengths from about 200 nanometers to 16 microns.

The illustration 500 may be obtained based on data collected by a detector that senses energy having wavelengths in the visible band, near-infrared, and/or short-wavelength infrared spectral bands. Sensing energy at some or all of these spectral bands may improve the signal-to-noise ratio for energy sensed from the thermal decomposition of explosives that combust at temperatures exceeding the temperature of the sample collector 312 (e.g., explosives that combust at temperatures higher than 300° C.). The improved signal-to-noise ratio may improve detection of this type of explosives as well as providing an alternative or supplemental way to classify explosives based on an “onset” determined from the spectral radiance curve. The onset is the wavelength at which emissions begin due to combustion. Explosive materials tend to have an onset at lower wavelengths than non-explosive materials because explosives have emissions of higher energies than non-explosives. Additionally, the spectral radiance of explosives tends to increase sharply and be concentrated at lower, higher-energy (or “bluer”) wavelengths. In contrast, non-explosives have an onset at higher wavelengths and the spectral emissions from non-explosives tend to be spread over a larger range of wavelengths.

In particular, a spectral radiance curve 510 produced by heating 10 nanograms of a particular explosive material and a spectral radiance curve 520 produced by heating 1 nanogram of the same explosive material show an onset 525 that occurs at a particular wavelength 527. The spectral radiance 530 of the 300° C. blackbody has an onset 535 the occurs at a second wavelength, which is a longer wavelength than the wavelength associated with the onset of the explosive material. Thus, the spectral radiance curves 510 and 520 can be used to determine that the substances that produced the curves 510 and 520 are explosives. Additionally, because the onset wavelength varies with the explosive, the onset wavelength may be used to classify the explosive in addition to determining that an explosive is present. Finally, a magnitude of the spectral radiance curve 510 and the spectral radiance curve 520 may indicate an amount of the explosive present in the samples. For example, integrating under the curve 510 and the curve 520 provides an estimate of the amount of explosive present in the sample. For example, as seen in FIG. 5, the spectral radiance of the 10 nanogram sample is greater than that of the 1 nanogram sample.

Referring to FIG. 6, a flow chart of an example process 600 for discriminating between energetic materials and clutter is shown. In more detail, the example process 600 uses an onset value to determine whether energetic materials are present. The example process may be performed by a system such as the system 100 described above with respect to FIG. 1 or the system 300 described above with respect to FIG. 3.

Energy released from energized samples is detected (610). The samples may be collected or harvested on a sample collector such as the sample collector 312, and the samples may be heated by heating the sample collector 312 with an energy source such as the energy source 314. The detected energy is analyzed to determine a spectral radiance (620).

An onset value is determined based on the spectral radiance (630). As discussed above, the onset value is a wavelength at which the energized sample begins to emit radiation. The onset value is associated with a wavelength and a magnitude. Whether an energetic material is included in the energized samples is determined based on the onset value (640). The determination of whether an energetic material is included in the energized samples may be made based on the value of the wavelength associated with the onset. For example, excited energetic materials tend to begin emitting radiation at lower wavelengths than clutter. Thus, the wavelength associated with the onset may be used to classify the sample as an energetic material. In some implementations, the magnitude of the spectral radiance at the onset value may be used to determine whether an energetic material is included in the samples. For example, and referring briefly to FIG. 5, as compared to the spectral radiance of the 300° C. blackbody, the example explosives have a greater spectral radiance than the value of the spectral radiance at the onset associated with the 300° C. blackbody.

If it is determined that the samples include an energetic material, the energetic material is classified based on the determined onset value (650). For example, the onset value varies among different explosives, thus the determined onset value may be used to identify the energetic material as a particular type of explosive (e.g., the explosive may be identified as TNT). In some implementations, the onset value may be used to classify the energetic materials as belonging to a class of explosives (e.g., plastic explosives). In some implementations, the onset value may be used to classify the energetic material as something other than clutter. In yet another example, the onset value may be used to classify the energetic material as an explosive precursor.

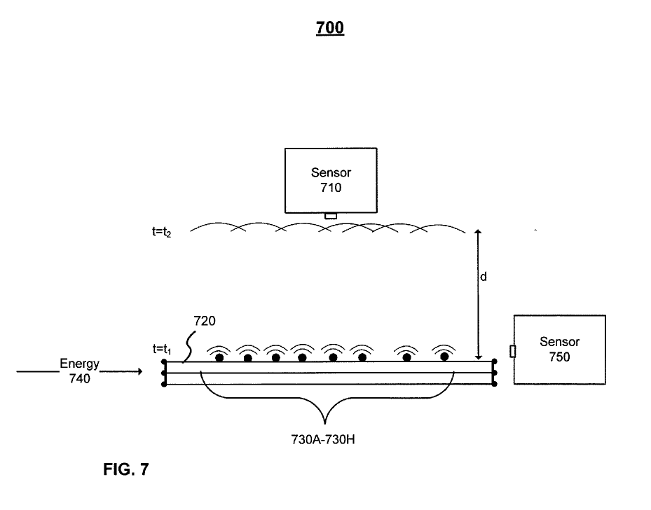

Referring to FIG. 7, a side view of an example thermal decomposition system 700 is illustrated. In more detail, the system 700 may be used to discriminate energetic materials from clutter. The system 700 is similar to the system 100, and the system 700 is shown as a side view along line A-A′ of FIG. 1. The system 700 includes a sensor 710 located a distance “d” above a surface 720. The surface 720 may be a sample collector such as the sample collector 312 discussed with respect to FIG. 3. Samples 730A-730H reside on the surface 720 and are excited and emit radiation as the surface 720 is heated by the energy source 740. The system 700 also may include a second sensor 750 located at or near the surface 720.

The sensor 750 monitors emissions from the heated samples at a time t₁, which coincides with the time of the thermal decomposition. The emissions at the time t₁ may be referred to as “prompt radiation.” The sensor 710 monitors emissions a distance “d” above the surface 720, and these emissions are measured at a time t₂. The emissions measured at time t₂ and at the distance “d” may be referred to as “not prompt radiation.” As the radiation produced by the thermal decomposition travels over the distance “d,” the gases produced by the decomposition relax and expand. Thus, the spatial characteristics of the emissions measured at t₁ and t₂ are different. Analysis of the relaxation and expansion of the gases may help identify the samples as energetic materials, and also may help to determine the proportion and location of energetic materials on the surface 720. In some implementations, the samples may be classified as, for example, particular energetic materials, belonging to a class of energetic materials, as explosive precursors and/or as a substance other than energetic materials.

Although the example shown in FIG. 7 includes two sensors, sensors 710 and 750, the system 700 may be implemented with one sensor or with more than two sensors. In some implementations with more than one sensor, one or more of the sensors may be sensitive to energies of different wavelengths than other sensors. In some implementations, all of the sensors may be sensitive to the same wavelengths. Because emissions from substances of interest vary with wavelength, including sensors sensitive in various spectral bands may improve performance of the system 700. In implementations with one detector, snapshots of the spatial characteristics of the emissions measured at the times t₁ and t₂ may be recorded.

Referring to FIG. 8, an example process 800 discriminates between energetic materials and clutter. The process 800 may be performed by a system such as the system 700 discussed above with respect to FIG. 7. Energy released from energized samples is detected at a first time (810). For example, energy may be detected at the time t₁ discussed above with respect to FIG. 7. Energy released from energized samples is detected at a second time (820). For example, the energy may be detected at the time t₂ discussed above, and the energy may be detected at the distance “d” shown in FIG. 7. The energy detected at the first time and the energy detected at the second time are compared to determine whether the samples include energetic materials (830). The energy detected at the first time and/or the second time may be analyzed to determine the emission spectra, and the emission spectra may be compared to the emission spectra of materials known to be energetic materials. Whether the samples include energetic materials may be determined based on the comparison (840). Additionally, the energy detected at the first time and the energy detected at the second time may be correlated spatially. From the spatially correlated energy, the number of samples that are energetic materials may be determined.

Referring to FIGS. 9A and 9B, some alternative implementations of the system 100 are illustrated. The illustrations shown in FIGS. 9A and 9B are side views of the systems 900A and 900B taken along the line A-A′ of FIG. 1.

FIG. 9A illustrates a side view of an example thermal decomposition system 900A. In more detail, the system 900A uses resistive heating to heat a surface 905. The system 900A includes a conductive surface 905 that collects and holds samples 910A-910H, a control system 915, and a sensor 920. The surface 905 is made from a conductive material so that the samples 910A-910H are heated as the surface 905 is heated. The control system 915 directs the flow and duration of current through the surface 905. Various types of current signals may be produced by the control system 915. For example, the control system 915 may produce a step current to cause the samples 910A-910H to quickly undergo thermal decomposition. In another example, the control system 915 may produce a ramp current that increases at a constant rate. Because different energetic materials undergo thermal decomposition at different temperatures, use of a ramp current may allow more determination of the types of energetic materials present on the surface 905. Other shapes of current waveforms such as, for example, plateaus and triangle waveforms, may be produced by the control system 915. In some implementations, the control system 915 may include a feedback system configured to adjust the current signal according to conditions measured on the surface 905. For example, the system 900A may include a temperature sensor that measures the temperature of the surface 905 and provides the measured temperature to the control system 915. In this implementation, the control system may increase or decrease the current signal supplied to the surface such that the temperature of the surface 905 is maintained at, for example, 300° C.

In one implementation, the surface 905 is a 400 mesh, 316 grade stainless steel that includes openings of 38 microns between the wires that make up the mesh. The mesh is heated electrically using a power supply operating at 4.5 volts and approximately 22 amps. In another example, the surface 905 may be directly coupled to a conductor.

Referring to FIG. 9B, a detection system 900B uses radiative heating to heat a surface 930. The system 900B includes the surface 930, which holds samples 935A-935H, a radiation-producing device 940, and a sensor 945. In the system 900B, radiation 950 from the radiation-producing device 940 is directed to the surface 930, and the radiation 950 causes the surface 930 to heat, which causes the samples 935A-935H to heat and thermally decompose when the surface 930 heats to a sufficient temperature (such as 300° C.). The sensor 945 monitors the surface 930 as the surface 930 heats. The sensor may be the sensing system 330 described above with respect to FIG. 3.

The radiation-producing device 940 may be, for example, a flash lamp or an infrared laser (such as, for example, a Q-switched YAG laser). The radiation-producing device 940 may be placed from 1 to several meters from the surface 930 depending on the power level output by the radiation-producing device 940. In the example shown in FIG. 9B, the radiation-producing device 940 is shown located below the surface 930. However, the radiation-producing device 940 may be located to the side or above the surface 930. The example shown in FIG. 9B includes a single radiation-producing device 940, but in some implementations, more than one radiation-producing device may be used and positioned in various locations around the surface 930. More than one type of radiation-producing device may be used.

Other implementations may include additional or other features. For example, the radiation-producing device 940 may be designed to release set amounts of energy without requiring a pyrometer for control.

Referring to FIG. 10, illustrates an example of an impact collector 1000. In more detail, the example impact collector 1000 may be used to deposit one or more air streams that includes samples of materials onto a collection surface 1010. The collection surface 1010 may be a collection surface such as the sample collector 312 described with respect to FIG. 3. The samples deposited onto the collection surface 1010 may be analyzed using a system such as the system 100 described above with respect to FIG. 1, the system 300 described above with respect to FIG. 3, and/or the systems 900A and 900B described with respect to FIGS. 9A and 9B.

The air streams may be generated by vacuuming an object to be tested for the presence of trace amounts of energetic materials. Examples of such objects include luggage and other packages, shipping containers, or a person's skin. Within the impact collector 1000, there is a critical flow to help ensure that the samples in the air stream reach the collection surface 1010 rather than falling out of the air stream and onto inner walls 1012, 1014, 1016 of the impact collector 1000. Ensuring that the samples reach the collection surface 1010 may help prevent false negatives, which may occur when the tested object actually includes trace amounts of energetic materials but samples from the trace amounts of the energetic materials never reach the collection surface 1010. Additionally, samples that become lodged on the inner walls of the impact collector 1000 may later fall back into the air stream and reach the collection surface 1010 during the testing of a second object that does not actually include energetic materials. These samples may lead to a false alarm (e.g., an erroneous determination that the second object actually includes energetic materials. In some implementations, the impact collector 1000 may be cleared after every positive detection of an energetic material to help prevent later false alarms resulting from samples left from earlier tests. The impact collector 1000 may be cleared by running the system without collecting sample material.

Samples flow into the impact collector 1000 in an air stream 1020. Samples carried by the air stream 1020 are deposited onto the collection surface 1010 because the samples are generally not able to remain in the air stream 1020 through the 180-degree turn at point 1018 as the air stream 1020 progresses toward the bypass line flow 1030. Thus, rather than remaining in the air stream 1020, the samples are deposited onto the collection surface 1010. Once the samples are deposited onto the collection surface 1010, the collection surface 1010 may be heated to trigger a thermal decomposition of the samples on the collection surface 1010.

In one example implementation, the inner diameter 1040 of the impact collector 1000 is about 1.5 cm. The outer ring 1040 is about 3 cm in diameter. In implementations with a rotating collection surface 1010, the impact collector 1000 is sealed to the collection surface 1010 using, for example, an O-ring included on the outer tube 1050 that forms a seal between the collection surface 1010 and the outer tube 1050. The impact collector may be implemented to have multiple air streams that collect particles from multiple sources.

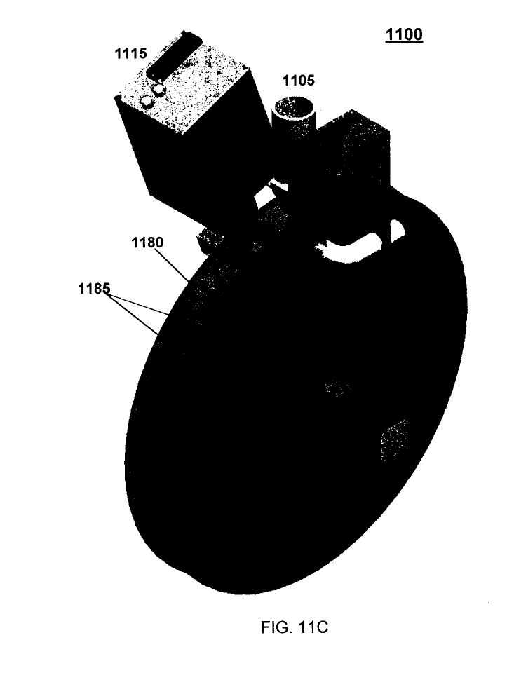

FIGS. 11A-11C illustrate an example of a collection and detection system 1100. In particular, FIGS. 11A and 11B illustrate an implementation that uses a carousel wheel with a reusable collection surface. In some implementations, a reel-to-reel system may be used. A reel-to-reel system may be more expensive to build and maintain as compared to a carousel system, but the reel-to-reel system also may hold more collection material such that the time between replacement of the collection surface may be greater.

Referring to FIG. 11A, a top view of a sample collection and detection system 1100 is shown. The system 1100 includes an impact collector 1105, a collection surface 1110, and a thermal decomposition system 1115. The impact collector 1105 may be the impact collector 1000, and the collection surface 1110 may be the collection surface 1010, each of which are discussed with respect to FIG. 10. The thermal decomposition system 1015 may be any of the systems 100, 300, 900A, and/or 900B described above.

In the system 1100, the impact collector 1105 deposits samples onto the collection surface 1110. A moving device 1120 (shown in FIG. 11B) moves the collection surface 1110, which is mounted on a carousel wheel 1125, such that the collection surface 1110, moves from a region adjacent to the impact collector 1105 to a region within the thermal decomposition system 1115. The samples deposited on the collection surface 1110 are then analyzed to determine whether the samples on the collection surface 1110 include trace amounts of energetic materials.

Referring to FIG. 11B, a side view of the collection and detection system 1100 is shown. In particular, a heating controller 1130 is shown. The discussion below refers to two example implementations that use resistive and radiative heating to heat the collection surface 1110 such that thermal decomposition of samples on the collection surface 1110 is triggered. However, other methods of initiating thermal decomposition may be used. For example, the temperature of the samples may be increased using any type of electromagnetic radiation, convention to heat the sample using warm air, and/or the sample may be heated using conduction.

In the system illustrated in FIG. 11B, the collection surface 1110 is within the carousel wheel 1125, and the collection surface 1110 includes either a series of discreet collecting areas or a continuous collection area. In a series of steps, the collection and detection system 1100 gathers collected samples onto an area of the collection surface 1110. The detection system 1100 rotates the carousel wheel 1125 to allow the deposited samples to be analyzed for the presence of energetic materials.

The carousel wheel 1125 includes “stations,” which refer to specific locations or degrees of rotation of the carousel wheel 1125. A first station on the carousel wheel 1125 is the impact collector 1100, which may be sealed to the carousel wheel 1125. The positions of the stations may be determined by the position of holes along the circumference of the carousel wheel 1125. After particles are deposited onto the collection surface 1110 using the impact collector 1000, the carousel wheel 1125 rotates to a second station, which is the thermal decomposition system 1115.

A moving device 1120 rotates the collection surface 1110, and in the implementation discussed above, the carousel wheel 1125. A stepper motor or a DC motor (either unidirectional or bidirectional) may be used to move the carousel wheel 1125. An optical sensor (not shown) may be used to determine and control the position of the moving device 1120.

In one implementation that heats the collection surface 1110 using resistive heating, the collection surface 1110 has an area of three square-centimeters, and the collection surface 1110 includes two contacts that are placed at opposite ends of the collection surface 1110. The contacts may be shaped in various ways, such as, for example, raised metallic contacts, rods, or plates. A spring loaded contact may be used to complete the connection. The carousel wheel 1125 may have an upper half and a lower half. In one assembly method, the upper half and the lower half are separated, the collection surface 1110 is installed on the lower half, and the upper half is attached on top of the collection surface 1110. In one implementation, for each portion of the collection surface 1110, one of the contacts is in the form of an electrode that is coupled to a common connection point (not shown), and the other contact is a separate connection. In such an implementation, the common connection point is constantly connected to the power supply, and the separate connection is selectively connected to the power supply, which allows only one portion of the collection surface 1110 to be resistively heated at a time. The collection surface 1110 may include openings to hold the optical sensors.

Residual material, such as oils, may contaminate or mask later measurements, or may shorten the life of a reusable collection surface 1110. By heating the collection surface 1110 to a higher temperature than that required to trigger decomposition of energetic material, such residual material may be burned off to clean the collection surface 1110. For example, temperatures in excess of 300° C. may be applied in order to thermally decompose remaining particles such that they are removed from the collection surface 1110.

A pyrometer (not shown) may be included in the thermal decomposition system 1115 or the heating controller 1130. During heating, there is slight expansion of the collection surface 1110. In order to prevent distortion, the collection surface 1110 may be designed such that there is a slight tension on the collection surface 1110.

Referring to FIG. 11C, a continuous collection material system 1175 includes a continuous conductive collection surface 1180, and discrete contact points 1185. In the system 1175, the continuous material 1180 is wrapped around the circumference of a wheel 1190. A portion of the continuous material 1180 is within the impact collector 1100 such that samples may be deposited on the continuous material 1180. As the wheel 1190 rotates, the continuous material 1180 moves within the thermal decomposition system 1115.

An electrical connection is established between the continuous material 1180 and a heating mechanism through the discrete contact points 1185. When the thermal decomposition system 1115 is activated, discrete contact points 1185 supply a current through the continuous material 1180, thus resistively heating the samples on the continuous material 1180. In order to prevent an electrical path through the full circumference of the continuous material 1180, a portion of the continuous material 1180 may be insulated or severed such that the continuous material 1180 does not form a complete loop.

The previous description provides example implementations of a collection and detection system 1100. Other implementations may include different or additional features. For example, a checking solution may be injected onto the collection surface 1110 test the ability of the system to detect the presence of energetic materials. This mechanism may include a reservoir that needs to be replaced periodically and may include, for example, a LEE miniature variable volume pump model number LPVX0502600B, available from the Lee Company of Westbrook, Conn. (see www.theleeco.com) or a small KNF model UNMP830 available from KNF Neuberger, Inc. of Trenton, N.J. (see www.knf.com) or similar pump and a LEE solenoid valve similar to LEE model number INKX051440AA.

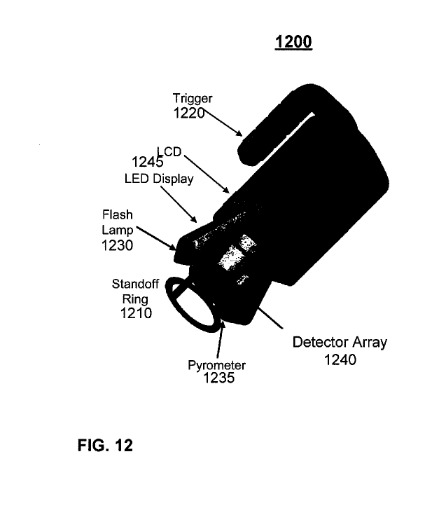

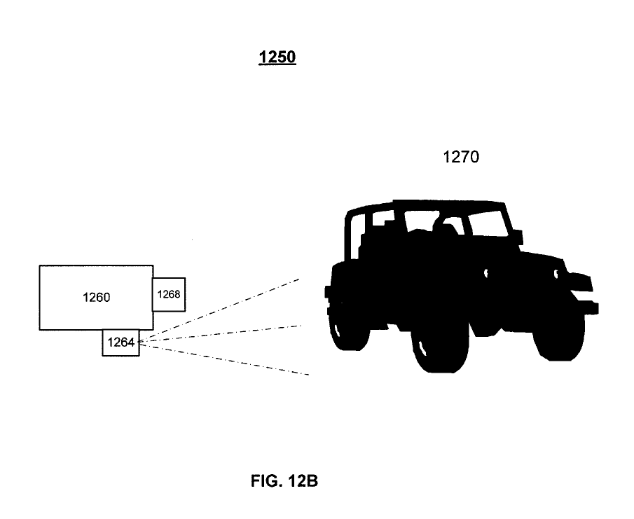

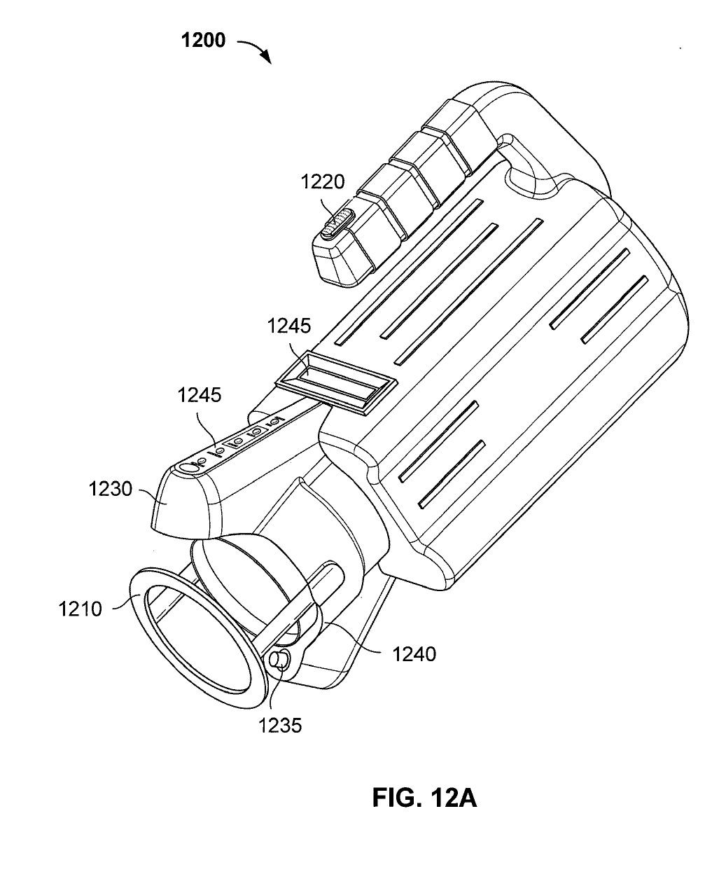

Referring to FIG. 12A, an example of a hand-held detection system 1200 is illustrated. The hand-held system 1200 includes a standoff ring 1210, a trigger 1220, a flash-lamp 1230, a pyrometer 1235, a detector array 1240, and output displays 1245. The device 1200 may be brought to the object to be tested in order to determine whether the object includes trace amounts of explosive particles.

To operate the device 1200, the user places the standoff ring 1210 on the area to be scanned for explosive particles. The standoff ring 1210 provides an appropriate distance between the sample and the IR detector array 1240. Next, the user operates a trigger 1220 to activate the flash-lamp 1230, which causes heating of the sample. The flash-lamp 1230 is aimed at the standoff ring 1210 and heats the sample to trigger thermal decomposition. The real-time temperature of the sample is measured through the pyrometer 1235. This temperature measurement is a part of a feedback loop that allows the temperature of the sample to be actively controlled by the flash-lamp 1230. The detector array 1240 monitors the sample area and detects energy produced by thermal decomposition. The detector array 1240 may be similar to the sensing system 330 discussed with respect to FIG. 3. The results are indicated on the output displays 1245.

Referring to FIG. 12B, an example of a ranged detection system 1250 is illustrated. The ranged detection system 1250 includes a detection device 1260 that operates as described above and may be aimed at an object 1270 at a distance. In the system 1250, the detection device 1260 emits radiation in the direction of the object 1270. After striking the object 1270, the radiation causes localized heating that triggers thermal decomposition of trace explosive particles. Radiation released from the decomposition is detected by the detection device 1260.

In particular, the detection device 1260 includes a flash-lamp 1264 and a distance focused detector array 1268. The flash-lamp 1264 emits a pulse of high-energy radiation sufficient to cause thermal decomposition at the object 1270. Emitted radiation strikes the detector 1268 and is detected. The detected radiation is analyzed as discussed above such that the presence of energetic materials may be determined, and, if energetic materials are present, the energetic materials may be classified.

The detection device 1260 may be enabled to operate at a distance of tens to hundreds of meters from the object 1270. Laser heating may be used as an alternative to flash-lamp heating. Laser hardware may be considerably more complex, power consuming, and expensive than hardware required for resistive or flash-lamp heating. As such, the use of a laser may be practical in implementations where the object 1270 is at a considerable distance beyond the immediate vicinity of the detection device 1260. Also, a telephoto lens may be included that focuses the detector array 1268 on an appropriately small area. In one implementation, the telephoto lens focuses the detector array 1268.

In one implementation, a checkpoint for explosives equips a detection device 1260 to detect vehicles for explosives. The detection includes operation of the flash-lamp across the sides of vehicles to detect explosives along various areas of the object 1270 being scanned. The previous descriptions provide exemplary implementations of handheld and range detection devices. Other implementations may include other, or different features. For example, various implementation, the detection device may be mounted in a variety of vehicles, such as, for example, an armored personal carrier, a tank, an aircraft, or a seacraft.

It is understood that other modifications are within the scope of the claims. For example, the techniques described above may be applied to detect and classify a variety of military-grade explosives as well as contaminated explosives, homemade explosives, common commercial explosive, explosive precursors, explosives that contain multiple species of other explosives, and other hazardous substances. For example, the techniques discussed above may be used to detect TNT, RDX, PETN, hydrogen peroxide, TATP, peroxide and sugar mixtures, ammonium nitrate, and smokeless powder.

What is claimed is:

1. A method of discriminating between energetic materials and clutter, the method comprising:
sensing energy released from energized particles;
determining whether the energized particles include a possible energetic material based on the sensed energy;
if a determination is made that the energized materials include a possible energetic material, determining a spectral signature of the sensed energy;
comparing the spectral signature of the sensed energy to one or more known spectral signatures associated with energetic materials; and
determining whether the possible energetic material is an actual energetic material based on the comparison.

2. The method of claim 1, wherein:
the spectral signature of the one or more known spectral signatures associated with energetic materials includes spectral emission bands at particular wavelengths, the spectral emission bands being produced by emissions at the particular wavelengths resulting from thermal decomposition of the energetic materials, and
comparing the spectral signature of the sensed energy with the one or more known spectral signatures comprises determining whether the spectral signature of the sensed energy includes the spectral emission bands.

3. The method of claim 1 further comprising:
if a determination is made that the possible energetic material is an actual energetic material, determining a classification of the actual energetic material.

4. The method of claim 3, wherein determining a classification of the actual energetic material comprises determining a species associated with the actual energetic material.

5. The method of claim 3, wherein determining a classification of the actual energetic material comprises identifying the actual energetic material as a particular energetic material.

6. The method of claim 3, wherein determining a classification of the actual energetic material comprises:
determining that the actual energetic material includes one or more species belonging to a first set of energetic materials, and
determining that the actual energetic material does not include one or more species of energetic materials belonging to a second set of energetic materials based on the determination that the actual energetic material includes the one or more species belonging to the first set of energetic materials.

7. The method of claim 6, wherein the first set includes nitrogen and the second set includes species that do not include nitrogen.

8. The method of claim 1 further comprising generating an indication based on the determination of whether the possible energetic material is an actual energetic material.

9. The method of claim 1 further comprising:
if a determination is made that the possible energetic material is not an actual energetic material, classifying the spectral signature of the sensed energy as a clutter signature, and
storing the clutter signature in a library of clutter signatures.

10. The method of claim 1, wherein the actual energetic material comprises an explosive precursor.

11. The method of claim 1, wherein the actual energetic material comprises more than one species of explosive.

12. The method of claim 1, wherein determining a spectral signature of the sensed energy comprises resolving the sensed energy into spectral emission bands.

13. The method of claim 1, wherein:
determining a spectral signature of the sensed energy comprises determining a spectral radiance of the energized samples based on the sensed energy, and determining an onset value from the determined spectral radiance, the onset value associated with a wavelength and a magnitude, and
comparing the spectral signature of the sensed energy to one or more known spectral signatures comprises comparing the determined onset value to onset values associated with known energetic materials.

14. The method of claim 1, further comprising determining specific molar ratios of products and byproducts caused by the oxidation of the energetic materials, and wherein comparing the spectral signature of the sensed energy to one or more known spectral signatures associated with energetic materials comprises comparing the molar ratios of the products and byproducts with known molar ratios of energetic materials.

15. A system for discriminating between energetic materials and clutter, the system comprising:
a sample energizer configured to energize a sample area;
a sensing component configured to:
sense energy radiated from the sample area, and
resolve the sensed energy into one or more spectral bands; and
an analysis component configured to:
determine a spectral signature of the sensed energy,
determine whether the sample area includes possible energetic materials based on the spectral signature,
if a determination is made that the sample area includes possible energetic materials, compare the spectral signature to one or more spectral signatures associated with energetic materials, and
determine whether the possible energetic materials include actual energetic materials based on the comparison.

16. The system of claim 15, wherein the sensing component resolves the sensed energy into one or more bands using a non-dispersive optic.

17. The system of claim 16, wherein the non-dispersive optic comprises a band-pass filter.

18. The system of claim 15, wherein the sensing component resolves the sensed energy into one or more bands using a dispersive optic.

19. The system of claim 18, wherein the dispersive optic comprises a diffraction grating.

20. The system of claim 15, wherein the sample energizer is configured to heat the sample area to 300 degrees Celsius in one second.

21. The system of claim 15, wherein the sensing component includes a detector.

22. The system of claim 21, wherein the detector comprises at least one photomultiplier tube.

23. The system of claim 21, wherein the detector comprises at least one microbolometer.

24. The system of claim 21, wherein the detector comprises at least one photodiode.

25. The system of claim 21, wherein the detector comprises an array of detectors.

26. The system of claim 15, further comprising an output component configured to produce an indication of whether the sample area includes actual energetic materials.

27. The system of claim 15, wherein the sample energizer comprises a conductive mesh.

28. A computer program tangibly embodied on a computer-readable medium, the computer program including instructions that, when executed, cause an analysis component to perform operations comprising:
sensing energy released from energized particles;
determining whether the energized particles include a possible energetic material based on the sensed energy;
if a determination is made that the energized materials include a possible energetic material, determining a spectral signature of the sensed energy;
comparing the spectral signature of the sensed energy to one or more known spectral signatures associated with energetic materials; and
determining whether the possible energetic material is an actual energetic material based on the comparison.

29. A method of classifying energetic materials, the method comprising:
sensing energy released from energized particles;
analyzing the sensed energy to determine a spectral radiance of the sensed energy;
determining an onset value based on the spectral radiance, the onset value including a magnitude and a wavelength at which the onset occurs;
determining whether an energetic material is included in the energized particles based on the onset value; and
classifying the energetic material based on the onset value.

30. The method of claim 29 further comprising determining an amount of energetic material based on the magnitude of the onset value.

31. A method of classifying energetic materials, the method comprising:
sensing energy released from energized particles at a first time;
sensing energy released from energized particles at a second time;
analyzing the energy sensed at the first time and the energy sensed at the second time to determine a first spectral radiance and a second spectral radiance;
comparing the first spectral radiance and the second spectral radiance;
determining whether the energized particles include energetic materials based on the comparison; and
if a determination is made that the energized particles include energetic materials, classifying the energetic materials.

32. The method of claim 31, wherein comparing the first spectral radiance and the second spectral radiance comprises comparing spatial characteristics of the first and second spectral radiances.
